(19) United States
(12) Patent Application Publication
(10) Pub. No.: US 2007/0008119 A1
(43) Pub. Date: Jan. 11, 2007

(54) Temperature recording system having user selectable temperature ranges with radio frequency data transfer and G.P.S. based monitoring and communication capabilities

(76) Inventors: Budd Pohle, Camarillo, CA (US); Jan Williams, Santa Paula, CA (US); Yuri Yushkov, Buffalo Grove, IL (US)

Correspondence Address: Law Offices of Henry Bissell IV, 10616 Almond Ave., Oak View, CA, 93022-9233, US

(21) Appl. No.: 11/443,681

(22) Filed: May 30, 2006

Related U.S. Application Data
(60) Provisional application No. 60/685,796, filed on Jun. 1, 2005.

(51) Int. Cl. H04Q 7/00

(52) U.S. Cl. 340/539.22

(57) ABSTRACT

System incorporating devices employing radio frequency data transfer and G.P.S.-based capabilities for monitoring, recording, and reporting of environmental temperature conditions, incorporating a user-selectable range of environmental temperatures.

### CROSS-REFERENCE TO RELATED APPLICATION

This application claims the benefit of U.S. Provisional Application Ser. No. 60/685,796, filed Jun. 1, 2005. Filed concurrently with said Provisional Application was the requisite separate letter requesting retention of Disclosure Document No. 559,479. Said Disclosure Document entitled TEMPERATURE RECORDER HAVING USER SELECTABLE TEMPERATURE RANGE AND RADIO FREQUENCY TRANSMISSION CAPABILITIES was originally filed with the Patent and Trademark Office on Aug. 24, 2004. A copy of said letter is filed concurrently with this application.

### BACKGROUND OF THE INVENTION

1. Field of the Invention

The present invention generally relates to environmental condition sensing and recording devices and, more particularly, to temperature sensing and recording devices and their associated systems used to monitor and communicate the environmental temperature conditions of goods over a period of time, as during shipment or storage.

2. Description of the Related Art

There exist temperature recording devices with the ability for the manufacturer to preprogram the device to have a specific desired range for the chosen application, and subsequent recorded temperatures are then compared to this desired range. The user is alerted to observed temperatures occurring outside the set desired range. Of the devices with this ability, all require the recorder units to be individually pre-programmed using a PC, or ordered with the desired range pre-set by the manufacturer. None of the currently available recording devices enable the user to simply and conveniently select a desired temperature range from an offering of various available temperature ranges, nor do they enable the user to easily and inexpensive receive recorded data by using radio frequency enabled, handheld portable devices.

### SUMMARY OF THE INVENTION

The temperature recording system of the present invention provides novel and convenient means for users to monitor the environmental temperatures of goods in shipment or storage over a period of time. A variety of external temperature sensors can be used to particularly suit a variety of applications. User-selectable temperature ranges and remote radio frequency data retrieval are innovations providing previously unavailable flexibility. The incorporation of G.P.S. based tracking data and internet accessible bi-directional communications with the recording device during use provides real-time monitoring capabilities. Audible beeper features enable rapid location of recording devices.

### BRIEF DESCRIPTION OF THE DRAWINGS

A better understanding of the present invention may be realized from a consideration of the following detailed description, taken in conjunction with the accompanying drawings, in which:

FIG. 1 is a depiction of a typical course of use for a temperature recorder and some of the variety of options for data retrieval that are available;

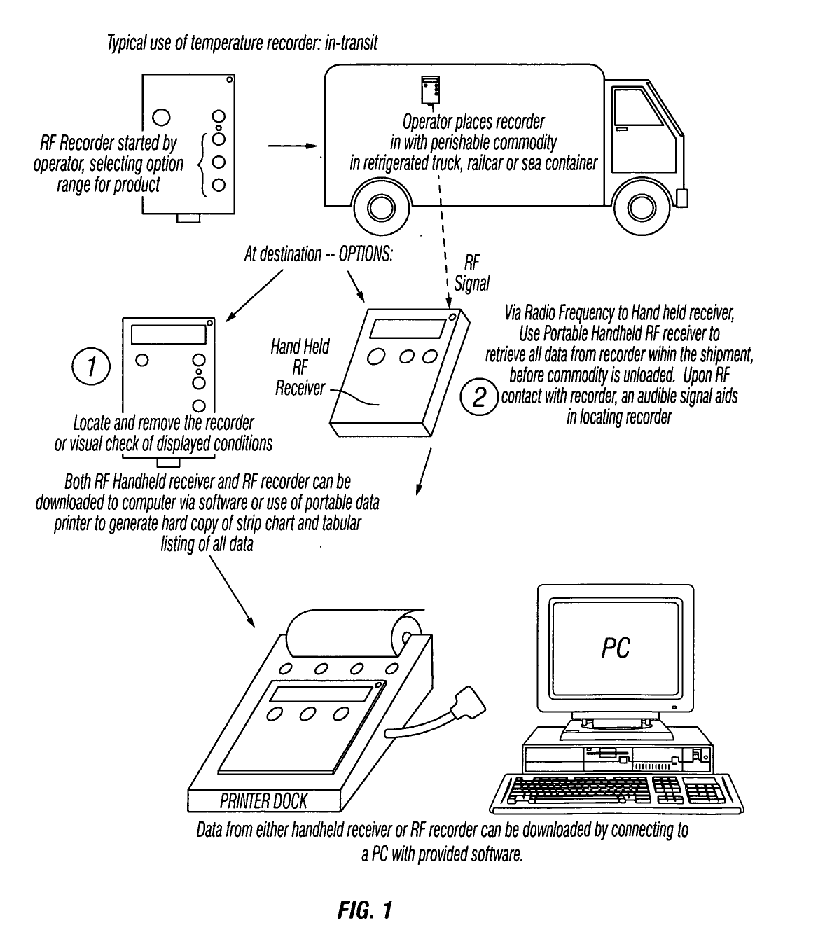

FIG. 2 is a depiction of a configuration of a temperature recorder, a remote handheld radio frequency unit, a reader/printer unit, and a computer, and it also notes some of the variety of options available for data retrieval;

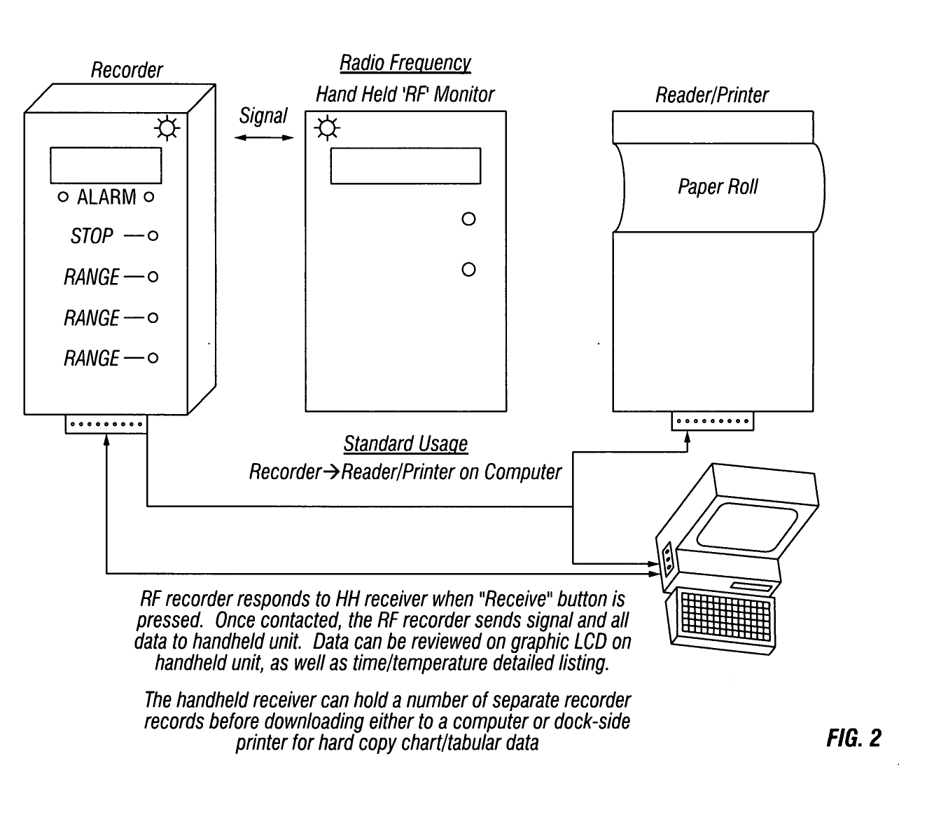

FIG. 3 is a front plan view of a remote handheld radio frequency receiver unit, for receiving, storing, and displaying data from a number of temperature recorder units;

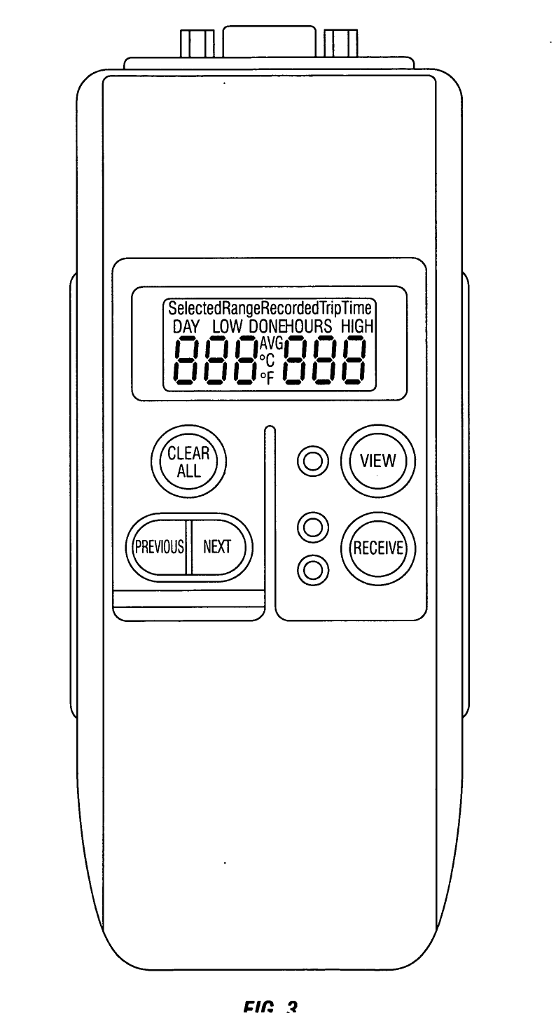

FIG. 4 is a rear plan view of a remote handheld radio frequency receiver unit, and showing a data communications port for downloading and/or printing collected data;

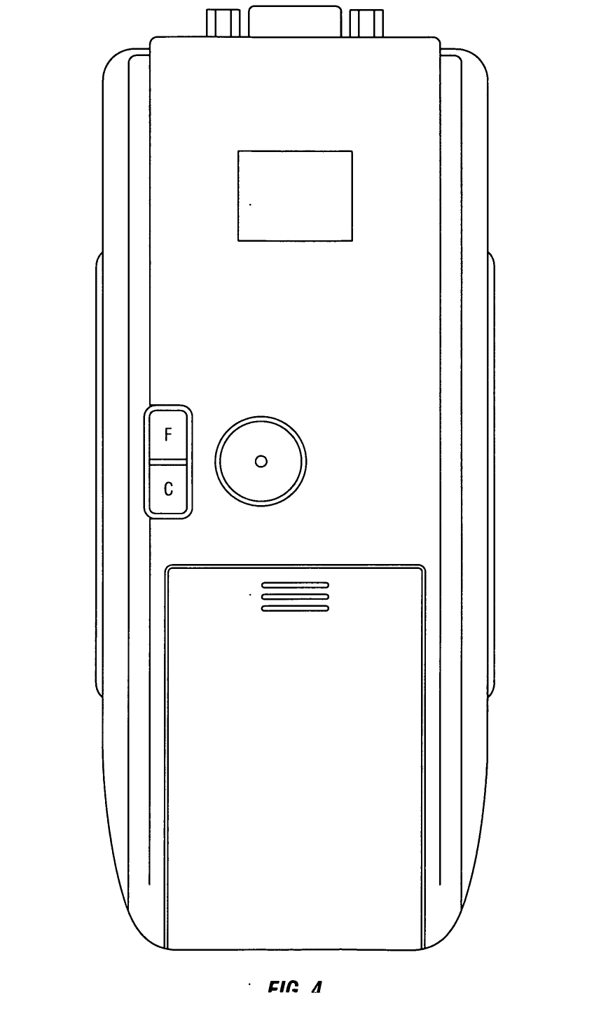

FIG. 5 is an end plan view of a remote handheld radio frequency receiver unit, and showing a data communications port for downloading and/or printing collected data;

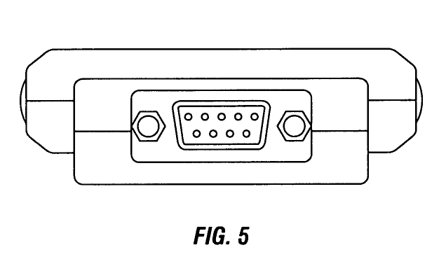

FIG. 6 is a perspective view of a temperature recorder device as described herein;

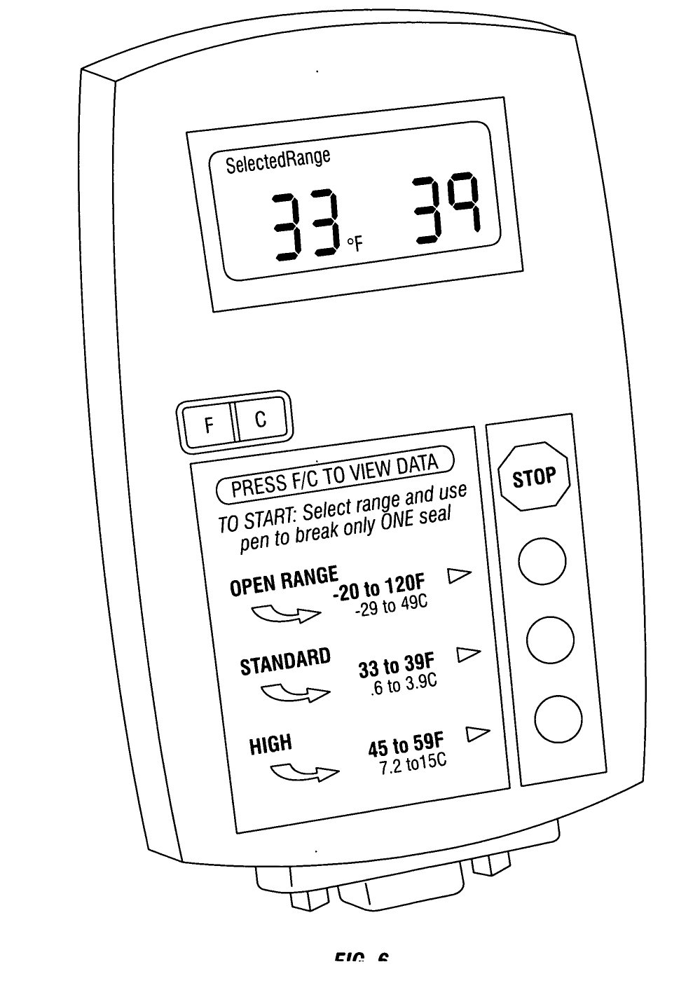

FIG. 7 is a depiction of a device communication network coordinating G.P.S. tracking data with temperature recorder data for transmission by way of GSM or satellite network;

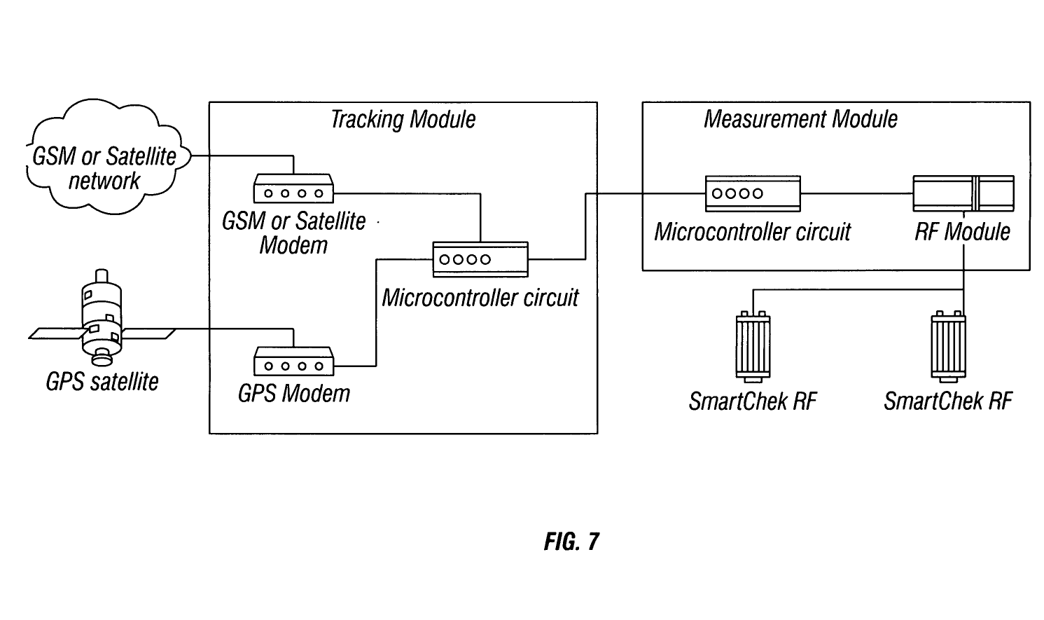

FIG. 8 is a depiction of a overall tracking network allowing users to obtain G.P.S. tracking data and temperature recorder data via the internet and numerous methods of access thereto;

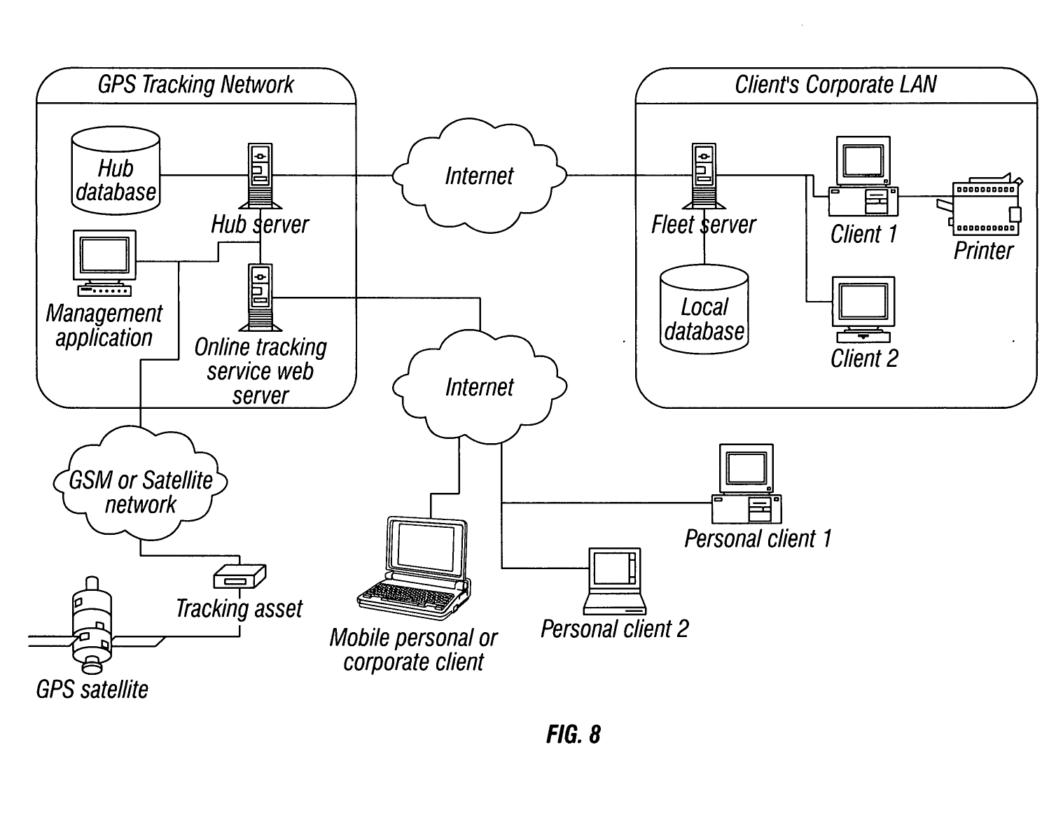

FIG. 9 is a depiction of data communication and interfacing of some of the various components of the present invention;

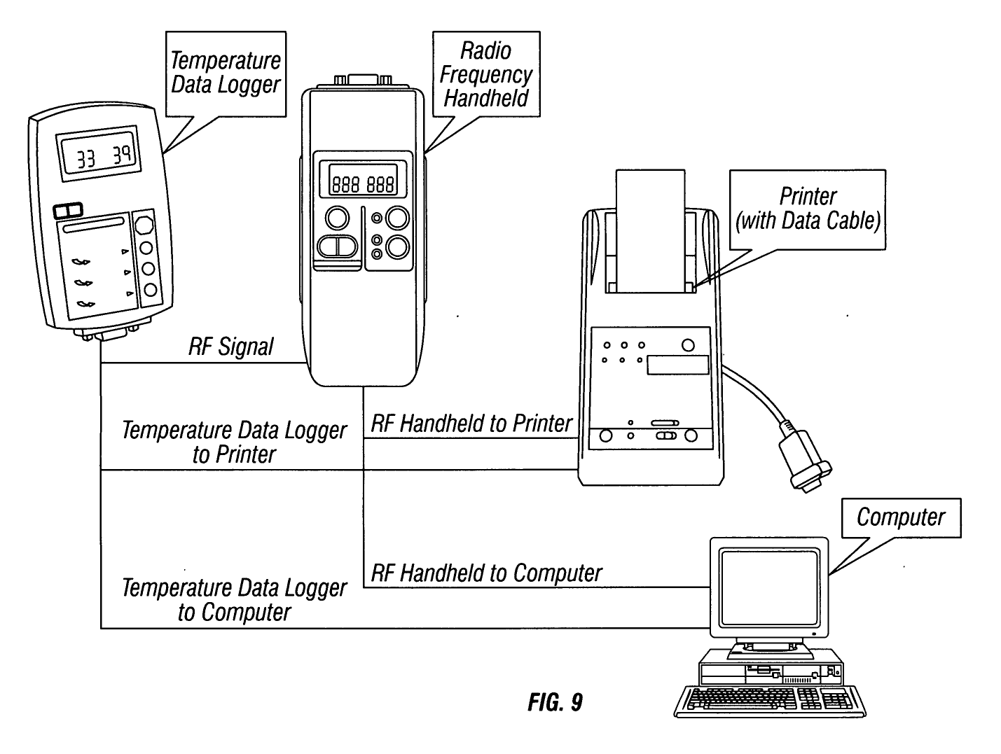

FIG. 10 is a depiction a front plan view of an alternate remote handheld radio frequency receiver unit, for receiving, storing, and displaying data from a number of temperature recorder units.

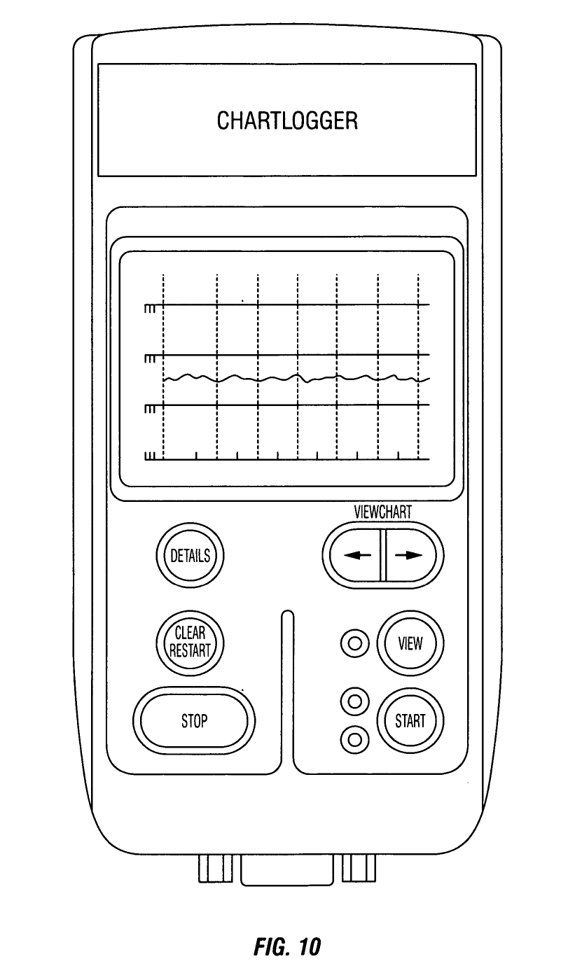

### DESCRIPTION OF THE PREFERRED EMBODIMENTS

Familiarity with the business of transporting temperature sensitive or other perishable goods has demonstrated the need for verifying the temperatures of such goods during shipping. Both shippers and receivers of such goods are interested in ensuring that the temperature of the shipment remains within a certain range of permissible temperatures, from the time it leaves the shipper's loading dock until it is delivered to the receiver for unloading.

The range of permissible temperatures differs from customer to customer, depending upon the requirements of the application. Over time, however, we have discovered that some temperature ranges are more commonly used than others. Accordingly, the present invention seeks to meet the needs of the overwhelming majority of our customers. This is accomplished in part, by enabling the customer to select the range of permissible temperatures which is best suited to the shipment or application at hand.

The temperature recorder of the present invention provides features which permit a user to select a desired temperature range from among a variety of temperature ranges, thereby enabling a user to monitor and ensure the temperature compliance of a variety of shipments more easily and rapidly. Should the observed temperature venture outside the desired temperature range, the temperature recorder signals an alarm to alert the user of the occurrence.

Other desirable features in a temperature recorder are reliability, tamper-resistance, versatility, and ease of use. The recorder of the present invention seeks to provide all of these features, and much more.

There exist recording devices with the ability for the manufacturer to preprogram the device to have a specific desired range for the chosen application, and subsequent recorded temperatures are then compared to this desired range. The user is alerted to observed temperatures occurring outside the set desired range. Of the devices with this ability, all require the recorder units to be individually pre-programmed using a PC, or ordered with the desired range pre-set by the manufacturer. None of the currently available recording devices enable the user to simply and conveniently select a desired temperature range from an offering of various temperature ranges.

The primary purpose driving the design and innovation of the present invention is convenience. In this case, convenience means to enable a user to push a button (or other similarly convenient means) and easily select, from a number of commonly used temperature ranges, that temperature range which best matches the critical temperature range which they are interested in ensuring or monitoring during a certain time period.

Buttons, switches, or similar means, located on the recording device enable the user to select the desired temperature range, thereby greatly increasing the convenience and versatility of using the recording device of the present invention. In addition, enabling the user to make this selection directly on the recording unit eliminates the burdensome need to connect the unit to a computer in order to set temperature ranges, as well as avoids the inconvenience of having to order devices with a specific temperature range preset by the manufacturer at the recorder factory.

The temperature recording device of the present invention provides a selection of commonly used temperature ranges. The desired temperature range may be selected by the user simply by pressing a button (or other similar means) on the recorder. In this way, the user is able to select the most suitable temperature range, depending upon the commodity requirements and their application needs.

This temperature recorder enables the customer to select, from a number of possible temperature ranges, that temperature range which best matches the permissible temperatures for their product while in transit or during some other temperature critical time interval. The device then notifies the user if the observed temperatures ventured out of the selected temperature range.

In its standard configuration, the temperature recorder contains a temperature sensor. However, where the requirements of a particular application call for a temperature probe or other specific configuration, the recorder may be configured so that the temperature sensor is located outside the recorder and connected by the necessary wiring. Such a configuration could provide for a temperature sensor mounted within a stainless steel probe, connected to the recorder by wiring encased within a plastic or woven stainless steel sheath. In this way, the temperature probe can be inserted into an individual product or container for monitoring internal temperatures. Utilizing well known plugs and receptacles, the temperature recorders can be outfitted with one of a variety of temperature sensors, wherein each sensor is particularly adapted to a specific application.

The temperature recording device is tamper-resistant, yet easy to start and operate. It can also provide for a variety of methods of accessing the collected data; for example, by observation of an LCD or similar visual display, by observing a series of color-coded LED or similar lights, by external computer such as a Windows or Mac PC, by electronic downloading to a separate, compatible handheld unit, by remote accessing via a handheld unit employing radio frequency transceiver capabilities, or by viewing a hard copy, paper print out of the recorded data. Any number of these methods are available for viewing the collected data.

Print-outs of data collected by the temperature recorder device can be obtained in several ways: for example, by plugging the temperature recording device into a compatible handheld device integral with, or connected to, a designated printer; by connecting the temperature recording device to a PC and then printing the data to a printer connected or networked to the PC; by gathering the collected data via radio frequency transmission to a handheld unit connected to a designated printer.

Accessing or transferring the collected data by way of radio frequencies is a convenient feature which enables the shipment receiver to remotely access the in-transit temperature data prior to unloading the entire shipment and having to locate the data recorder. If the party receiving the shipment is at all suspicious of the product condition, this radio frequency enabled, remote access feature allows for reject/accept decisions to be made sooner, saving labor and time if the shipment is to be rejected.

Another feature of the present invention is the incorporation of audio and/or visual signaling components. By incorporating signaling components into the recording device, the device is able to alert the user that the recorded temperature traveled outside (either above or below) the selected range for an unacceptable interval.

In addition, the device is able to activate such audible and/or visible signaling components to announce its location, when activated to do so. Such activation can be set to occur after a certain time interval has passed, or can be achieved through use of the radio frequency handheld unit. This feature greatly assists in the often difficult task of locating and recovering the recording device within a refrigerated truck or other monitoring location.

Such audio/visual alerts enable the recording device to “announce” its location in order to make the device easy to locate among the shipment products. Examples of such components can include LEDs, LCDs, lights, buzzers, or speakers.

This device locator feature can be configured to function continuously from initiation of device operation, or it can be triggered by the occurrence of some event, for example, the passage of a predetermined amount of time. It can also be triggered by a preselected radio frequency signal. Such a signal is generated by the radio frequency handheld device that is compatible with the temperature recorder. This device locator feature can also be programmed to discontinue after a specified period of time in order to preserve battery life.

The handheld radio frequency unit is able to download collected data from multiple recorders, with the ability to gather and store data for subsequent printout. This allows the shipping receiver to access data from a number of incoming shipments without requiring them to stop what they are doing in order to dock and print the data from each temperature logger. Instead, the radio frequency handheld unit is capable of remotely collecting data from a number of delivered shipments containing radio frequency enabled temperature recorders.

When gathering data from a number of temperature recorders, any recorders that experienced temperatures outside the selected temperature range will be “red-flagged”. This highlighted status can be identified in a number of ways. The temperature recorder device itself will display a visual indicator to show a temperature out of range condition occurred. Also, the handheld device, as well as the radio frequency handheld device, will display a visual indicator as well. Such visual indicators could be a message displayed on an LCD, a flashing LCD, an illuminated or flashing LED or other light, etc. In this way, when data is collected from a number of recorders, those that recorded out of range incidents will be readily apparent.

The data collected by such temperature recorder devices can be displayed in a number of manners and formats. The data may be printed out or viewed on the display of the recorder or the handheld unit. The data may be viewed or printed out in a manner resembling the traditional strip chart format.

As an innovative alternative to conventional data presentation, the temperature recorder of present invention enables the user to review the collected data by way of “time at temperature”. The data is presented to the user degree by degree, and for each degree, the amount of time the temperature remained at that degree.

The time at each degree would be cumulative, and would not necessarily be a direct reflection of a plot of time versus temperature. Rather, the data presented would reflect the accumulated time elapsed at each individual degree over the entire course of the recording period.

Data presented in this “time at temperature” format is of great benefit to the user, as it quickly and accurately answers the all important questions of “How high/low did the temperature get?” and “How long was it at that temperature?” None of the other currently available temperature monitors provides this vital information in this convenient format.

One possible design of a temperature recorder device with user selectable range in accordance with the present invention incorporates a printed circuit board; an integrated circuit micro-controller; an LCD monitor (or similar display); a series of buttons (or similar controls) for selecting the desired temperature range and to stop the unit's operation and to view the collected data; an LED (or similar indicator, possibly red in color); a data connection interface, e.g. an RS-232 port (or USB, mini-USB, or similar port), a location indicator buzzer or light source, and a battery-provided voltage supply, all contained in a (preferably plastic) case.

Additionally, to enable the radio frequency capabilities detailed herein, the temperature recorder unit is outfitted with a chip-based radio frequency transceiver and an antenna.

A separate handheld device provides remote accessing and observation of data from the recorder unit by way of a radio frequency interface. In one preferred configuration, the radio frequency enabled handheld device includes an enclosing case made of plastic or similar protective material, an LCD (or similarly capable) display, a series of buttons (or similar controls) for navigating the various features of the device, at least one data connection interface (e.g. RS-232, USB, mini-USB or similar port or cable) to enable connecting to other devices (including but not limited to data recorders and printers), a power supply, nonvolatile memory, and a radio frequency modem to enable communication with data recorder units. Additional display devices, such as LED's, etc., may be used to indicate selected status conditions. For example, one or more LED's may be employed to indicate the device is searching for RF Recorders, downloading data, completed downloading data, “out of range” conditions, device power status, battery condition, battery charging state, or other conditions. The LED's may utilize different colors and/or variable flash durations or intensities to communicate the desired information.

The power required by the handheld device may be supplied by one or more batteries, rechargeable or other type, or AC outlet, via an appropriate adapter.

A separate printer unit accessory allows “docking” of the handheld device for accessing recorded data. One possible configuration in accordance with the present invention has a printing unit, a power supply, and connector contacts for accessing recorded data and recharging the recorder unit. Such units are well known in the art.

Printing of recorded data can be achieved by a number of methods. The recording unit can be placed in the printer dock or connected to a computer for printing out data collected. In addition, the handheld unit can be connected to either the printer dock or a computer for printing out data retrieved remotely from the recording unit;

When the recorded data is printed out, the temperature range selected by the user would appear shaded or highlighted (or otherwise emphasized) on the printout, in order to call attention to its significance.

The radio frequency enabled handheld unit is able to establish communications with, and download data from, multiple radio frequency enabled recorders for later, subsequent printout. This allows a shipment receiver to access data from a number of incoming shipments without requiring them to stop after each one to dock and print the data. Rather, the unit will accumulate data from several recorders for docking and printing at the receiver's convenience. Since the data downloaded from the each recorder to the remote handheld device includes the serial number or other identifier for that specific recorder, the user of the handheld unit is able to easily identify and distinguish the data sets from each of the different recorders.

As an additional feature, the temperature recording device may be equipped with an optional measurement and tracking module system.

The measurement module portion of the system includes a radio frequency module and a micro-controller circuit, and is able to remotely gather data from a number of temperature recorder units using radio frequencies. The measurement module then communicates the collected data to the tracking module.

The tracking module portion includes a micro-controller unit, an integrated circuit board, a global positioning satellite (G.P.S.) modem unit, and a GSM or satellite communications modem. The measurement and tracking module can be carried in the cab of a big rig truck, or on the wall of a warehouse.

In cooperative operation with the G.P.S. enhanced temperature recorder, the measurement and tracking module allows users to determine the location of their shipments, ascertain the temperatures observed and the temperature histories recorded, as well as whether any temperature range violations have occurred. Users will be able to send and receive messages to and from the measurement and tracking module, as well as transmit information to other wireless devices.

The temperature, history, location, route, and communication information gathered from the measurement and tracking module is monitored and stored by a centralized G.P.S. tracking network. Such G.P.S. tracking network includes a hub server, a hub database, a management application, an online tracking service web server, and a GSM or satellite network connection.

Users of this system can monitor the temperature recorders in use through the internet or their own corporate local area network (LAN). Such a LAN includes a fleet server connected to a local database, and operative connection to at least one client, which may be a desktop PC. The client may be connected to a printer. The fleet server is operatively connected through the internet to the hub server of the G.P.S. tracking network.

Data collected by the temperature recorders, combined with G.P.S. data and other communications gathered by the measurement and tracking module, are transmitted by GSM or satellite modem through a GSM or satellite network to the G.P.S. tracking network. Once the data arrives at the G.P.S. tracking network, it is stored in the hub database and made available to individual users. Such users may access their data through their own company's corporate LAN, or by the internet and a personal computer.

With the wealth of capabilities provided by the introduction of the measurement and tracking module to the temperature recorder system of the present invention, users are able to access vital temperature data across a variety of shipments and warehouses, learn the position of their shipments, and be able to do so from a wide variety of locations via the internet.

This invention possesses a great number of novel features which are not found or disclosed in the prior art:
The ability for the user to select their desired temperature range from a number of available temperature range options located on the recording device.
The ability for the recording device to employ a variety of external temperature probes.
Audible and/or visual locator features integrated into the recording device.
Remote access of recording device data through use of a radio frequency enabled remote handheld unit.
The availability of multiple methods of obtaining data from the recording devices.
The ability to view recorded data in a novel and informative “time at temperature” format.
The ability to view recorded data on a graphic display, depicting temperatures based on a time line.
The ability to receive recorded data from a number of corresponding data recorders through use of a handheld radio frequency enabled device.
The ability for the handheld device to identify each recorder's data by a preassigned recorder identifier or serial number.
The ability to gather data from several recording devices for subsequent docking and printout.
The ability to track recorded data, determine temperature recorder geographic location, and transmit and receive messages and commands to and from wireless devices.

This invention provides the user with ease of use, versatility, and flexibility in the monitoring of temperature over time that is unavailable from other devices in the marketplace. No prior art device provides the novel features and benefits provided by the device described above.

Although there have been described herein above various specific arrangements of a TEMPERATURE RECORDING SYSTEM HAVING USER SELECTABLE TEMPERATURE RANGES WITH RADIO FREQUENCY DATA TRANSFER AND G.P.S.-BASED MONITORING AND COMMUNICATION CAPABILITIES in accordance with the invention for the purpose of illustrating the manner in which the invention may be used to advantage, it will be appreciated that the invention is not limited thereto. Accordingly, any and all modifications, variations or equivalent arrangements which may occur to those skilled in the art should be considered to be within the scope of the invention as defined in the annexed claims.

What is claimed is:

1. A system of apparatus for monitoring, recording, and reporting environmental temperature, comprising a recorder for sensing and storing monitored values, and a handheld device for downloading data from at least one said recorder for subsequent display or other output.

2. The system of claim 1, wherein said recorder and said handheld device include a radio frequency module for enabling wireless communications between each said recorder and said handheld device.

3. The system of claim 2, wherein said handheld device includes:
non-volatile memory means for storing temperature data received from one or more of said recorders;
integrated circuit means for controlling components and performing data operations;
output means for transferring data to a printer or computer;
enclosure means for containing components;
display means for visually communicating information to a user;
a plurality of control components for enabling user navigation of data and device configuration;
LEDs for communicating device or recorder status or data conditions; and,
power supply means for providing necessary electricity.

4. The system of claim 1, wherein said recorder includes:
integrated circuit means for controlling other components of the recorder, performing temperature measurements, saving raw temperature data, communicating with external devices, and controlling displays and user inputs;
temperature sensor means;
measurement network means, coupled to said integrated circuit means and said temperature sensor means, for measuring and translating temperature sensor means output into ambient temperature;
non-volatile memory means for storage of raw temperature data and recorder configuration data;
control and display component means for enabling interfacing with a user;
sound generating means for emitting an audible locating or alarm sound responsive to predetermined data conditions or receipt of external signal;
serial port means for enabling initial recorder configuration and readout of non-volatile memory data;
battery means for providing power to the recorder.

5. The system of claim 4, wherein said recorder includes a radio frequency module for enabling wireless communications between said recorder and said handheld device.

6. The system of claim 3, wherein said handheld device includes control means for controlling the emission of audible sound by said recorder.

7. A system for remotely indicating the value of at least one parameter of an environment within an enclosed space which is detected by a sensor which is located within said space, the system comprising:
a first apparatus including:
a sensor for detecting said values within said enclosed space and having an output for providing signals corresponding to the detected values;
means coupled to said output for recording said signals over a predetermined time interval and providing a record thereof;
a radio transmitter coupled to said recording means for transmitting radio signals corresponding to selected portions of said record; and
a second apparatus located remotely from said first apparatus and including:
a radio transceiver for receiving transmissions of signals corresponding to said selected record portions from said transmitter; and
control means coupled to said transceiver for causing the transmitter to transmit said signals corresponding to said selected record portions.

8. The system of claim 7 wherein said first apparatus includes means for emitting an audible sound, and wherein the control means of said second apparatus includes means for controlling the first apparatus to emit an audible sound.

9. The system of claim 7 wherein said detected parameter is the temperature within said space.

10. The system of claim 7 wherein first apparatus includes means for establishing preset threshold levels to determine an acceptable range of variation of temperatures and wherein said recording means includes means for recording data indicative of:
(1) the time when the temperature is outside of said acceptable range;
(2) the duration of time interval during which temperature is outside of said range;
(3) the maximum and minimum temperatures attained when the recorded temperature is outside of said range; and
(4) the time when the temperature crosses said threshold into said acceptable range.

11. The system of claim 7 wherein said second apparatus is installed in a housing which is sized to permit holding in the hand of a user.

12. The system of claim 11 wherein said second apparatus includes means for displaying signals which are received from said first apparatus.

13. The apparatus of claim 12 wherein said second apparatus is a handheld unit further including printing means for providing a printed record of said display.

14. The system of claim 7 wherein said enclosed space is a transport vehicle having refrigeration means for cooling the contents of said enclosed space to a range of temperatures below outside ambient temperatures and for transporting product loaded into said enclosed space to a destination location; and
wherein said second apparatus is available at said destination location to control the first apparatus to transmit said selected data.

15. The system of claim 7 wherein said first apparatus further includes means for recording Global Positioning Satellite (GPS) location data over a specified time interval;
and wherein said second apparatus includes means for indicating the geographical points at which the recorded temperatures were outside of said acceptable range.

16. The system of claim 7 wherein said second apparatus includes a battery for powering said second apparatus, and means for coupling said second apparatus to electrical power mains to recharge said battery.
